(19) United States
(12) Patent Application Publication
(10) Pub. No.: US 2009/0177388 A1
(43) Pub. Date: Jul. 9, 2009

(54) Method For Operating A Navigation System

(76) Inventor: Thorsten W. Schmidt, Kitzingen (DE)

Correspondence Address: QUARLES & BRADY LLP, 411 E. WISCONSIN AVENUE, SUITE 2040, MILWAUKEE, WI, 53202-4497, US

(21) Appl. No.: 12/334,696

(22) Filed: Dec. 15, 2008

(30) Foreign Application Priority Data
Jan. 8, 2008 (DE) 10 2008 003 395.2

(51) Int. Cl. G01C 21/36

(52) U.S. Cl. 701/209

(57) ABSTRACT

A method for operating a navigation system includes the following steps:
a) calculating a route from a starting point to a destination, wherein the route consists of a sequence of road segments and junctions between the road segments that is selected from a database in which a geographic area is described by means of road segments and junctions with a route calculation method,
b) calculating at least one lane instruction that contains instructions for the user in order to follow the calculated route in the form of a lane change maneuver based on the current position, and
c) calculating and displaying a schematic lane image (12) on a display unit, wherein the schematic lane image (12) graphically displays the lane instruction in schematic form, wherein
c1) a first lane course (13) is calculated that shows the lanes prior to the lane change maneuver, particularly at the current position;
c2) a second lane course (14) is calculated that shows the lanes during the lane change maneuver, and
c3) a combination of the first and the second lane course is displayed in the schematic lane image (12).

### CROSS-REFERENCE TO RELATED APPLICATION

This application claims the priority benefit of German Patent Application No. 10 2008 003 395.2 filed on Jan. 8, 2008, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention pertains to a method for operating a navigation system.

### BACKGROUND OF THE INVENTION

Navigation systems of the generic type are used, for example, as mobile navigation devices in order to direct the driver of a motor vehicle from a starting point to a destination. For this purpose, the navigation device retrieves data from a database in which a geographic area is described in the form of road segments and junctions. Consequently, the database contains a network of road segments and junctions between these road segments that describe the road system, particularly the road network, in machine-readable form and thusly can be processed by means of corresponding algorithms in a data processing system.

A suitable route calculation method is used for selecting from this data of the database a route in the form of a sequence of road segments and junctions that directs the user from the starting point to the destination.

However, known navigation systems not only calculate the route from the starting point to the destination. Navigation systems also calculate maneuvering instructions that, based on the current position along the route, instruct the user to execute certain maneuvers in order to follow the route. For example, if the user arrives at a road intersection, maneuvering instructions are calculated that instruct the user to turn in the corresponding direction at the road intersection.

Different options are available for outputting the maneuvering instructions for the user. The maneuvering instructions are typically output acoustically in the form of a voice announcement. With respect to a turning maneuver at an intersection, for example, the system may output the following announcement: “Please turn left at the next intersection.” However, the acoustic output of maneuvering instructions has the disadvantage that they are no longer continuously available to the user after the announcement. If the user did not understand the acoustic maneuvering instructions, they either need to be repeated or the user needs to continue maneuvering without instructions. In order to solve this problem, known navigation systems utilize so-called schematic maneuvering images. At least the next maneuver to be executed and/or the maneuver after the next maneuver to be executed is graphically displayed in schematic form in the schematic maneuvering image, wherein this graphic illustration is permanently displayed on a display unit until the corresponding maneuver has been executed. In addition, known navigation systems also display in schematic form which lanes are suitable for executing the maneuver at the location of the maneuver.

However, since only the suitable lanes at the location of the maneuver are displayed, the driver is unable to determine if lane changes are required prior to the maneuver in order to reach the suitable lanes. This is the case, in particular, if at the time of displaying the suitable lanes the current lane course does not correspond to the lane course at the location of the maneuver, especially if the number of lanes at the current position does not correspond to the number of lanes at the location of the maneuver. In this type of situation, the driver is unable to determine how the lane course will change prior to the maneuver. Consequently, the driver may still have to execute lane changes shortly before the maneuver. If the traffic situation does not allow such last-minute lane changes, the driver may be unable to execute the planned and displayed maneuver and may consequently be forced to diverge from the calculated route and to take a detour.

### SUMMARY OF THE INVENTION

Based on this prior art, the present invention provides a new method for operating a navigation system that makes it possible to select the lanes suitable for following the calculated route in a timely and reliable fashion, as well as to altogether minimize the number of lane changes and to enable the driver to execute the required lane changes in a timely fashion.

One embodiment of the inventive method is based on the fundamental idea of calculating the lane course at the current position, particularly prior to a lane change maneuver, and the lane course during a lane change maneuver in order to display the lanes, wherein a schematic combination of both lane courses is graphically displayed on the display unit of the navigation system in the form of a schematic lane image. Consequently, the driver is provided with a clearly arranged and intuitive illustration that shows the changes of the lane course and thusly enables the driver to orient himself along the lane course in a timely fashion.

In order to increase the information content of the schematic lane image, it is advantageous to not only calculate the lane course prior to and during the lane change maneuver, but also after a lane change maneuver, and to display this additionally calculated lane course in combination with the first and the second lane course. This is particularly sensible in instances in which the lane course changes shortly after a lane change maneuver, for example, if two or more lanes merge or a regular lane changes into a turn lane.

According to another advantageous embodiment, it is proposed to also display the lane course after a turning maneuver that follows the lane change maneuver. This is particularly sensible if one lane is available for the turning maneuver, but the road reached after the maneuver features more than one lane.

In one particularly advantageous variation, this situation is displayed for all roads that can be reached after the maneuver. Consequently, the user always encounters the same basic structure of the schematic lane image at the same intersection, wherein only the maneuvering lane course changes when the driver heads for different roads.

Due to the analysis of the calculated lane courses, an optimal path for following the calculated route in the form of the lane change maneuver is calculated for each lane change maneuver and is displayed as a maneuvering lane course in the schematic lane image on the display unit of the navigation device. Prior to a lane change maneuver, this illustration enables the driver to determine in a timely fashion how the lane course will change and which lanes need to be chosen at what time in order to execute an imminent lane change maneuver with the utmost safety and a minimum of lane changes and, in effect, to safely and smoothly follow the calculated route.

In order to improve the clear arrangement and the associated ability of the driver to read the image, the displayed maneuvering lane course is optically highlighted in the schematic lane image. The ability to optimally read the image is particularly important when a driver follows an unfamiliar route in dense inner-city traffic. In such instances, the driver needs to be completely focused on the traffic situation in order to understand and execute the information and instructions for following the calculated route as quickly as possible.

In a number of lane change maneuvers, it may occur that the navigation device calculates several equally suitable paths for executing the lane change maneuver. Based on the original lane at the current position or the traffic situation at the location of the lane change, these different paths may be more or less suitable for executing the lane change maneuver. Consequently, it is particularly advantageous to illustrate and display in a schematic lane image all alternative paths in the form of maneuvering lane courses.

Alternatively, ensuing lane maneuvers may also be analyzed with suitable methods. If two or more maneuvering lane courses that represent alternative paths along the route are available, this would make it possible to always display in the schematic lane image only the at least one maneuvering lane course that is suitable for executing the ensuing lane maneuver. It is also proposed to display the at least one aforementioned maneuvering lane course that is suggested for ensuing maneuvers in an optically highlighted fashion such that the driver is not only able to recognize the other maneuvering lane courses, but also to anticipate that a lane change will have to be executed prior to or soon after the imminent maneuver in order to follow the planned route.

Detours caused by unintentionally diverging from the calculated route can be advantageously reduced if lane courses in schematic lane images, in which lanes are structurally separated from one another, are also displayed in an optically separated fashion. If a lane change maneuver along a lane course with structurally separated lanes is not executed correctly or in a timely fashion, the driver frequently has to take a long detour. The driver can be alerted of the situation in a timely fashion due to the optically separated illustration of structurally separated lanes in the schematic lane images and therefore is able to follow the displayed maneuvering lane course in order to ensure that he does not diverge from the calculated route.

The schematic lane image essentially may be displayed in any suitable way. Depending on the type of display of the navigation device, however, it may be advantageous to choose different forms of displaying the image.

In order to improve the resemblance between the traffic situation and the image on the display unit of the navigation device, the schematic lane image may be realized in the form of a schematic illustration of the traffic situation, particularly the intersection situation. If such a schematic lane image is displayed on the display unit of a navigation device, it is easier for the driver to identify the schematic lane image as the current traffic situation and to correctly execute the instructions of the maneuvering lane course.

The display of the schematic lane image parallel to other image contents can improve the clear arrangement of the display unit of the navigation device. This is the case, in particular, if other schematic maneuvering images and/or the traffic situation is/are also displayed in addition to the schematic lane image. In this case, the parallel display of several image contents ensures that a multitude of information can be displayed in a clearly arranged fashion permanently and, in particular, individually or as a whole.

The schematic lane image may also be drawn into the map section to be illustrated and may be displayed on the display unit of the navigation system, wherein this is particularly advantageous if the map is displayed in the form of a top view and the scale of the displayed map section makes it possible to display the schematic lane image in a clearly arranged fashion.

With respect to mobile navigation devices or navigation devices with display units of limited size, it is sensible to display only the schematic lane image on the display unit of the navigation device. In this case, the display of the schematic lane image may, in particular, but by no means exclusively, represent the only display mode of the navigation device.

The utilization of a navigation device is also very useful for the driver without the activated navigation to a destination, particularly if the navigation device is operated in accordance with the inventive method. For example, the display of schematic lane images that show all lane courses within a certain distance from the current position promotes an anticipatory driving behavior even when the navigation to a destination is deactivated. Although no maneuvering lane courses can be displayed without a calculated route, a schematic lane image provides the driver with valuable information on the upcoming lane courses that cannot be recognized with the naked eye in many instances.

The data required for generating the schematic lane images is advantageously calculated by analyzing data sets of digital road maps. Consequently, the schematic lane images can be very accurately generated and easily updated.

In order to minimize the computing power of the navigation device during the operation, it is sensible to already calculate the information on lane courses beforehand and to store this information in a digital memory card format. In this case, the information on lane courses is directly read out of the data memory at a certain distance between the current position and a lane change maneuver. Due to this pre-processing step, it is no longer necessary to determine and analyze the current lane course and other lane courses during the operation of the navigation device.

Different aspects of the inventive method are schematically illustrated in the drawings and are described in an exemplary fashion below.

### BRIEF DESCRIPTION OF THE DRAWINGS

FIG. 1 shows image contents on the display unit of a known navigation system;

FIG. 2 shows a schematic representation of a schematic lane image;

FIG. 3 shows image contents on the display unit of an inventive navigation system;

FIG. 4 shows alternative image contents on the display unit according to FIG. 3; and

FIG. 5 shows an exemplary intersection situation with a corresponding schematic lane image in the form of a top view.

### DETAILED DESCRIPTION OF THE EXAMPLE EMBODIMENTS

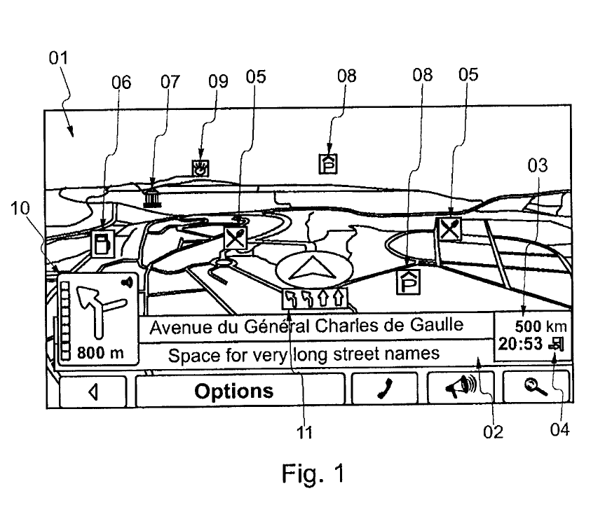

FIG. 1 shows an example of the image contents displayed on the display unit of a known navigation system. The main content consists of a top view of the immediate surroundings in the form of a map 01. A multitude of information is displayed on the map 01, as well as on the remainder of the display unit, for example, the street name 02, the distance from the destination 03, the estimated arrival time 04, the closest restaurants 05, fueling stations 06, museums 07, parking garages 08 and points of interest 09. If a route from a starting point to a destination was calculated, additional information and instructions are output in order to assist the driver in following the calculated route. This includes schematic maneuvering images 10 that schematically display the next maneuver to be executed and schematic lane images 11 that show lanes suitable for executing the next maneuver. However, the schematic lane images 11 are not very sensible and may even have a confusing effect on the driver, particularly if the lane course at the current position does not correspond to the lane course at the location of the next maneuver. In this case, the driver is not provided with instructions and/or information as to how the lanes suitable for following the calculated route can be reached. The schematic maneuvering images 10 and the schematic lane images 11 on the display unit merely indicate that a left turn maneuver is imminent and that the two leftmost lanes can be used for this purpose.

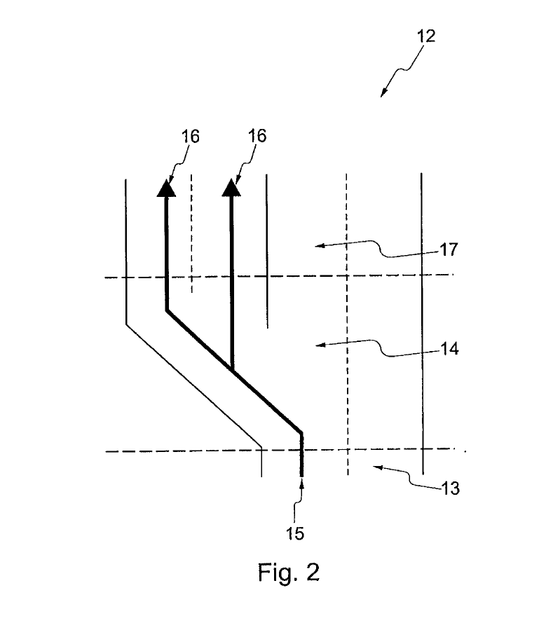

FIG. 2 shows a schematic lane image 12 that schematically illustrates the lane course 13 at the current position, the lane course 14 during a lane change maneuver and the lane course 17 after the lane change maneuver. The three lane courses 13, 14 and 17 are separated from one another by broken lines in FIG. 2 in order to provide a better overview. In addition, a maneuvering lane course 15 displayed in the schematic lane image 12 indicates the lanes suitable for following the calculated route in an optically highlighted fashion. The schematic lane image 12 contains two maneuvering lane courses 15 that symbolize alternative paths 16 on the calculated route. The display of alternative paths 16 enables the driver to react to the traffic situation at the location of the lane change and to choose the optimal path. If so required based on the traffic situation, the lane course 17 after the lane change maneuver is also illustrated in a schematic lane image 12 in addition to the lane course 13 prior to the lane change maneuver and the lane course 14 during the change maneuver. Furthermore, structurally separated lanes are also illustrated in an optically separated fashion in the schematic lane images 12.

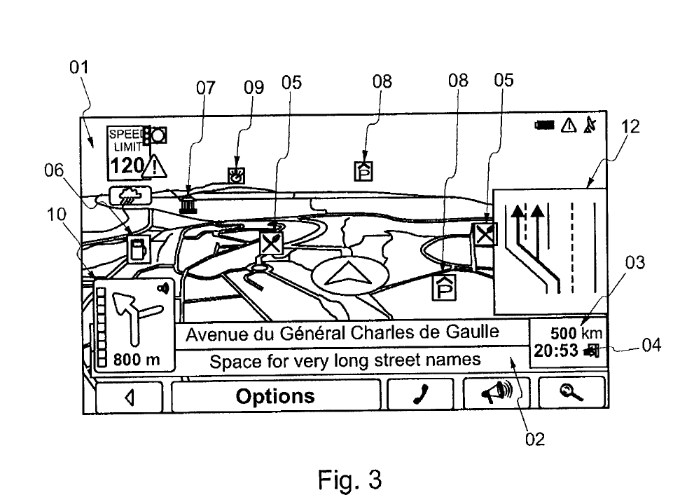

FIG. 3 shows the image contents on the display unit of a navigation system incorporating the present invention. In addition to information and instructions such as, for example, the street name 02, the distance from the destination 03, the estimated arrival time 04, the closest restaurants 05, fueling stations 06, museums 07, parking garages 08 and points of interest 09 that are also displayed on the display unit of the known navigation system, the image contains a schematic lane image 12 rather than the somewhat confusing schematic lane image. Consequently, the driver is not only provided with information on the type and the distance of the next maneuver in the form of a schematic maneuvering image 10, but also with information on the changes of the lane course and the preferred lanes in the form of a schematic lane image 12. In this preferred embodiment, the driver can easily ascertain that two lanes that will be situated to the left of the currently existing lanes are available for turning left at the Y-intersection, and that at least one lane change to the left will be required before the next turning maneuver can be executed.

If several lanes at an intersection are suitable for executing the maneuver, the lanes most suitable for the ensuing maneuver(s) are displayed in an optically highlighted fashion and/or are exclusively displayed. For example, if two lanes turn left and the next maneuver consists of a right turn, only the right maneuvering lane course of the two maneuvering lane courses is displayed in an optically highlighted fashion and is therefore suggested although both lanes are suitable for executing the imminent maneuver at this intersection.

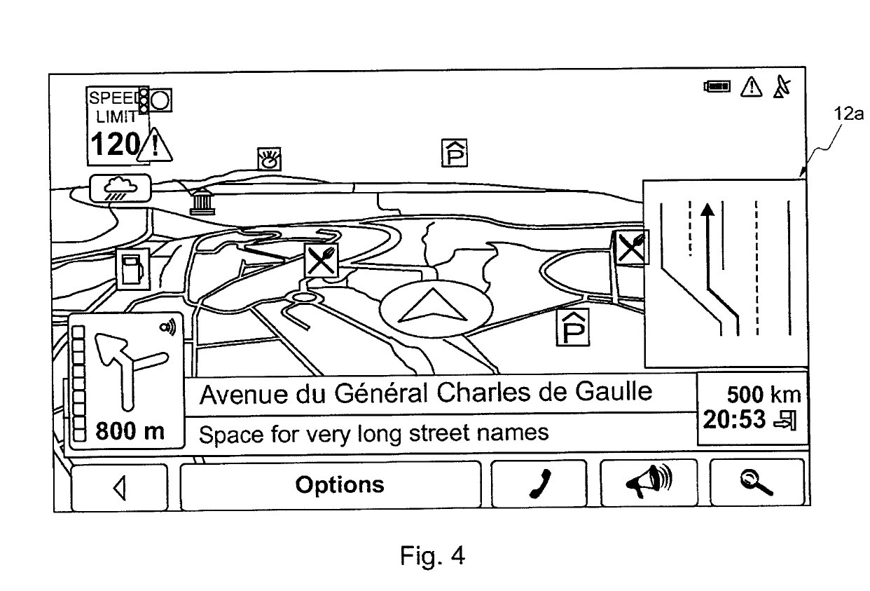

FIG. 4 shows the image contents of the display unit according to FIG. 3. The schematic lane image 12a can be distinguished from the schematic lane image 12 in that only the right lane of the two lanes at the Y-intersection is displayed in an optically highlighted fashion in order to inform the driver that he should choose this lane.

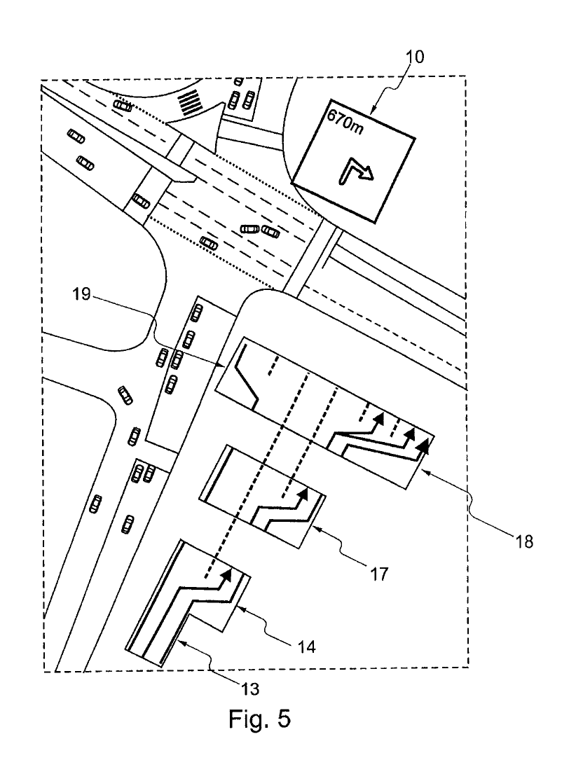

FIG. 5 shows a top view of an exemplary traffic situation with a corresponding schematic lane image that also shows the lane course 18 after a turning maneuver. In this figure, the lane course 19 for a right turn maneuver is displayed in the components of the schematic lane image in such a way that two lanes, the right lane 14 of which should be chosen, are created from a one-lane road 13. Subsequently, another lane branches off such that the right lane 17 should once again be chosen.

The driver reaches a two-lane road after the turning maneuver, wherein both lanes 18 may be chosen in this case because no other maneuver that would make it necessary to choose one of the lanes 18 needs to be executed in the immediate vicinity in accordance with the calculated route.

After the maneuver, the schematic image of the lane course also makes it possible for the driver to ascertain that he can turn into three roads (left, right and straight ahead), and that a two-lane road follows in each case.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

1. A method for operating a navigation system with the following steps:
a) calculating a route from a starting point to a destination, wherein the route consists of a sequence of road segments and junctions between the road segments that is selected from a database in which a geographic area is described by means of road segments and junctions with a route calculation method,
b) calculating at least one lane instruction that contains instructions for the user in order to follow the calculated route in the form of a lane change maneuver based on the current position, and
c) calculating and displaying a schematic lane image (12) on a display unit, wherein the schematic lane image (12) graphically displays the lane instructions in schematic form, in which
c1) a first lane course (13) is calculated that shows the lanes prior to the lane change maneuver, particularly at the current position;
c2) a second lane course (14) is calculated that shows the lanes during the lane change maneuver, and
c3) a combination of the first and the second lane course is displayed in the schematic lane image (12).

2. The method according to claim 1, in which a third lane course is also calculated that shows the lanes after the lane change maneuver, wherein a combination of the first, the second and the third lane course is displayed in the schematic lane image (12).

3. The method according to claim 1, in which a fourth lane course (18) is also calculated that shows the lanes after a turning maneuver that follows the lane change maneuver, wherein a combination of the first, the second, the third and the fourth lane course is displayed in the schematic lane image (12).

4. The method according to claim 3, in which all roads that can be reached by means of the turning maneuver are displayed in the schematic lane image (12) together with the fourth lane course (18).

5. The method according to claim 1, in which a maneuvering lane course (15) is calculated that shows the path to be driven during the lane change maneuver, wherein the maneuvering lane course (15) is displayed in the schematic lane images (12) together with the first, the second and the third lane courses.

6. The method according to claim 5, in which the maneuvering lane course (15) displayed in the schematic lane image (12) is illustrated in an optically highlighted fashion.

7. The method according to claim 1, in which at least two maneuvering lane courses (15) that represent alternative paths (16) along the route are displayed in a schematic lane image.

8. The method according to claim 1, in which at least one maneuvering lane course of at least two maneuvering lane courses that represent alternative paths along the route is displayed in an optically highlighted fashion and/or is exclusively displayed in a schematic lane image, wherein this at least one maneuvering lane course to be displayed is selected in dependence on an ensuing lane maneuver.

9. The method according to claim 1, in which structurally separated lanes are displayed in an optically separated fashion in the display of the lane courses.

10. The method according to claim 1, in which the schematic lane image (12) is displayed on the display unit of the navigation device in the form of a schematic illustration of the traffic situation, particularly intersection situations.

11. The method according to claim 1, in which the schematic lane image (12) is displayed on the display unit of the navigation device parallel to other image contents, particularly schematic map illustrations.

12. The method according to claim 1, in which the schematic lane image (12) is drawn into the map section to be illustrated and is displayed on the display unit of the navigation device.

13. The method according to claim 1, in which only the schematic lane image (12) is displayed on the display unit of the navigation device.

14. The method according to claim 1, in which schematic lane images (12) are displayed while the navigation function of the navigation device is deactivated, wherein no maneuvering lane course (15) is displayed in the schematic lane image (12), and wherein all lane courses within a certain distance from the current position are displayed in the schematic lane image (12).

15. The method according to claim 1, in which the schematic lane image (12) is calculated by analyzing data sets of digital road maps.

16. The method according to claim 1, in which the digital memory card format used for generating the schematic lane images (12) is optimized by means of pre-processing steps in such a way that the calculated information on the lane course is already contained in the memory card format and can be directly read out.
